(19) United States
(12) Patent Application Publication
(10) Pub. No.: US 2014/0229515 A1
(43) Pub. Date: Aug. 14, 2014

(54) APPARATUS AND METHOD FOR MANAGING FILES IN HYBRID STORAGE SYSTEM

(71) Applicant: Electronics and Telecommunications Research Institute, Daejeon (KR)

(72) Inventors: Dong Oh KIM, Daejeon (KR); Hong Yeon KIM, Daejeon (KR); Young Kyun KIM, Daejeon (KR)

(21) Appl. No.: 13/923,476

(22) Filed: Jun. 21, 2013

(30) Foreign Application Priority Data
Feb. 14, 2013 (KR) 10-2013-0016033

(51) Int. Cl. G06F 17/30

(52) U.S. Cl. CPC G06F 17/30082
USPC 707/822

(57) ABSTRACT

An apparatus for managing files in a hybrid storage system establishes a file management policy based on a directory unit using files stored in first and second storage devices and manages the files of the first storage device and the second storage device in accordance with the established file management policy based on the directory unit.

### CROSS-REFERENCE TO RELATED APPLICATION

This application claims priority to and the benefit of Korean Patent Application No. 10-2013-0016033 filed in the Korean Intellectual Property Office on Feb. 14, 2013, the entire contents of which are incorporated herein by reference.

### BACKGROUND OF THE INVENTION

(a) Field of the Invention

The present invention relates to a method and apparatus for managing files in a hybrid storage system.

(b) Description of the Related Art

In general, a high-speed storage device has excellent performance but has low capacity, whereas a low-speed storage device has poor performance as compared with a high-speed storage device, but has a high capacity.

A hybrid storage system includes a high-speed storage device and a low-speed storage device, and increases cost versus performance by properly using the high-speed storage device and the low-speed storage device.

If the high-speed storage device of the hybrid storage system is increasingly used, the hybrid storage system has better performance. Accordingly, the high-speed storage device needs to be always used by securing a space available for the high-speed storage device through a task for moving data stored in the high-speed storage device to the low-speed storage device having a high capacity or deleting the stored data.

In particular, the utilization of this high-speed storage device is increasing in order for a storage system to remotely provide files to a client terminal so that the client terminal uses the resources of a server like its own resources, such as a network file system or a distributed file system, to efficiently manage files and rapidly transfer the files to the client terminal for the purpose of sharing the resources of the server and a file system.

Several methods are being used in a hybrid storage system in order to improve speed. In one of them, a cache or NAND flash memory having high speed is chiefly used. However, the methods disclose a method of utilizing a high-speed storage device using an existing cache for storing a file in a block unit, but do not disclose a method of utilizing the meaning of a file, such as a directory, for the purpose of efficient file management.

### SUMMARY OF THE INVENTION

The present invention has been made in an effort to provide a method and apparatus for managing files in a hybrid storage system having an advantage in that a hybrid storage system can efficiently manage files of a high-speed storage device and a low-speed storage device.

According to an embodiment of the present invention, an apparatus for managing files in a hybrid storage system is provided. The apparatus for managing files includes first and second storage devices for storing files according to a file management policy based on a directory unit, a metadata management unit for establishing a file management policy based on a directory unit, and a data management unit for managing files of the first and second storage devices in accordance with the established file management policy based on the directory unit.

Managing the files may include at least one of monitoring, place, re-place, and movement of a file belonging to a corresponding directory.

The data management unit may generate a new file in accordance with a file management policy established in a directory of the first and second storage devices in which the new file will be disposed.

At least one of the metadata management unit and the data management unit may select a file to be moved and deleted in accordance with the file management policy based on the directory unit, and the data management unit may move and delete the selected file.

The metadata management unit may collect pieces of utilization information about the file in a unit of a directory to which the file belongs, analyze the pieces of collected utilization information, and establish the directory-based file management policy based on a result of the analysis.

According to an embodiment of the present invention, a file management method performed by an apparatus for managing files in a hybrid storage system including first and second storage devices for storing files is provided. The file management method includes establishing a file management policy based on a directory unit and managing the files stored in the first and second storage devices in accordance with the file management policy established based on the directory unit.

Managing the files stored in the first and second storage devices may include selecting a file to be managed in accordance with the file management policy established based on the directory unit and processing the file to be managed in accordance with a file management policy established in a corresponding directory, wherein the file to be managed may include at least one of a file to be moved and a file to be deleted.

Establishing a file management policy based on a directory unit may include collecting pieces of utilization information about a file based on the directory unit and analyzing the pieces of collected utilization information and establishing a file management policy for a directory to which the file will belong based on a result of the analysis.

Establishing a file management policy based on a directory unit may include establishing the file management policy based on the directory unit based on information received from a client terminal.

Managing the files stored in the first and second storage devices may include receiving a new file generation request from a client terminal, checking a file management policy for a directory in which a new file will be placed, and generating the new file in accordance with the file management policy for the directory in which the new file will be placed.

The file management policy may include place information and management information.

### BRIEF DESCRIPTION OF THE DRAWINGS

FIG. 1 is a diagram showing an apparatus for managing files in a hybrid storage system in accordance with an exemplary embodiment of the present invention.

FIG. 2 is a flowchart illustrating a method of generating a new file in accordance with an exemplary embodiment of the present invention.

FIG. 3 is a flowchart illustrating a method for managing files in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification and claims, unless explicitly described to the contrary, the word “comprise” and variations such as “comprises” or “comprising” will be understood to imply the inclusion of stated elements but not the exclusion of any other elements.

An apparatus and method for managing files in a hybrid storage system in accordance with exemplary embodiments of the present invention are described in detail below with reference to the accompanying drawings.

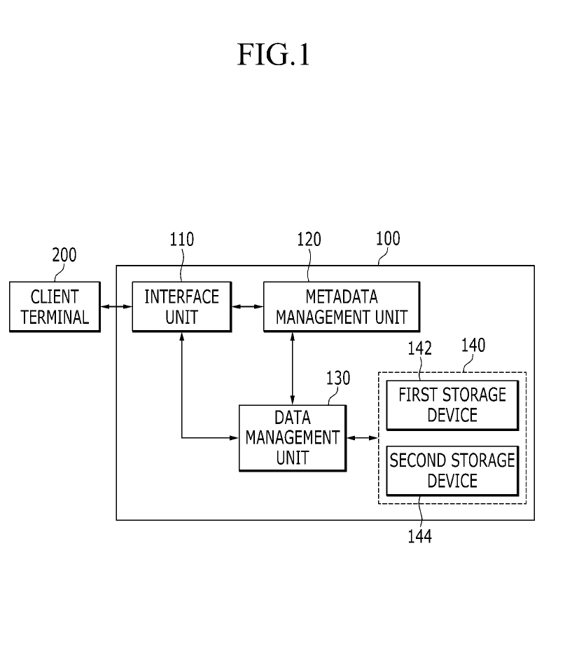

FIG. 1 is a diagram showing an apparatus for managing files in a hybrid storage system in accordance with an exemplary embodiment of the present invention.

Referring to FIG. 1, the apparatus for managing files 100 includes an interface unit 110, a metadata management unit 120, a data management unit 130, and a hybrid storage unit 140.

The interface unit 110 is a module responsible for communication connection with a client terminal 200.

The metadata management unit 120 manages the metadata of files, recognizes a first storage device 142 and a second storage device 144 of the hybrid storage unit 140, and establishes a file management policy based on a directory. The metadata management unit 120 can collect and analyze pieces of utilization information about a file based on a directory and establish a file management policy for files within a directory. Alternatively, the metadata management unit 120 may establish a file management policy based on information inputted by a user.

The data management unit 130 stores files in the hybrid storage unit 140 in accordance with a file management policy based on a directory, and manages the files stored in the hybrid storage unit 140. The data management unit 130 performs management, such as the monitoring, place, re-place, and movement of files that belong to a directory. A directory means a directory in a common file system, but may mean a specific category according to circumstances. For example, a directory may mean a category form, such as an avi file or an mp3 file.

The metadata management unit 120 and the data management unit 130 may be present in another machine.

Furthermore, the apparatus for managing files 100 may include at least one of the data management units 130, and each management unit 130 may be present in another machine.

The hybrid storage unit 140 includes at least one first storage device 142 and at least one second storage device 144.

Each of the first storage device 142 and the second storage device 144 stores files in accordance with a file management policy based on a directory unit.

The first storage device 142 and the second storage device 144 may be homogeneous storage devices or different storage devices. For example, the first storage device 142 and the second storage device 144 may be storage devices having different speeds. That is, the first storage device 142 may be a high-speed storage device having excellent performance but a low capacity, or may be a low-speed storage device having poorer performance than a high-speed storage device but a very high capacity.

A file management policy based on a directory unit indicates a rule for how a file will be managed based on a directory in the first storage device 142 and the second storage device 144. Furthermore, the file management policy can include a rule for how a file or a block forming a file will be disposed and processed in the first storage device 142 and the second storage device 144. More particularly, the file management policy can include a rule for where a file will be disposed in the first storage device 142 or the second storage device 144 when the file is first disposed, a rule for how long a file will be maintained if the file is disposed in the first storage device 142, a rule for whether some of the file or the entire file will be disposed in the first storage device 142, and a rule for whether a file stored in the second storage device 144 will be accessed after moving the file to the first storage device 142 or the file stored in the second storage device 144 will be accessed without change, when the file is accessed.

This directory-based file management policy is advantageous in that managed information and analyzed information are small and fast as compared with a collection and analysis method based on a file unit and thus overhead is minimized. Furthermore, since a policy is established based on a directory, the cache occupancy of unnecessary data can be reduced through faster processing by establishing the established policy to a new file.

The directory-based file management policy can be established based on all directories or can be established even up to a specific depth of a directory. Furthermore, several modifications are possible by controlling a directory unit having a minimum tracing unit if necessary.

Furthermore, a range of analyses into the association of a file is reduced because utilization information about the file is analyzed in a directory level, thereby being capable of rapid analysis.

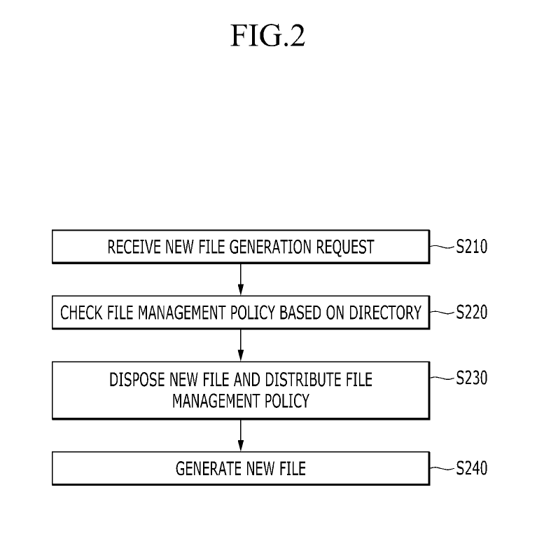

FIG. 2 is a flowchart illustrating a method of generating a new file in accordance with an exemplary embodiment of the present invention.

Referring to FIG. 2, if a user wants to generate a new file, the client terminal 200 transfers a new file generation request to the apparatus for managing files 100.

In response to the new file generation request received from the client terminal 200 at step S210, the interface unit 110 of the apparatus for managing files 100 transfers the new file generation request to the metadata management unit 120.

In response to the new file generation request, the metadata management unit 120 checks a file management policy established in a corresponding directory in order to determine a storage device in which the new file will be placed at step S220. Furthermore, the metadata management unit 120 distributes place information and management information to the client terminal 200 and the data management unit 130 in accordance with the checked file management policy at step S230. The place information can include information about the data management unit 130 that will generate the new file. The place information is information about a storage device in which a file or the block of a file will be stored. The management information can include conditions that a file or the block of a file is moved from the first storage device 142 to the second storage device 144, a method of moving a file or the block of a file from the first storage device 142 to the second storage device 144, and a file access method. The movement conditions refer to conditions in which a file stored in the first storage device 142 is moved to the second storage device 144 or conditions in which a file stored in the second storage device 144 is moved to the first storage device 142. The movement conditions can include, for example, the time that a file takes to be maintained in a storage device, the non-access time of a file, a designated time, and a file access time. The file movement method can include a common movement, a movement after compression, and a movement after integration. The file access method can include direct access and access after a file is moved to the first storage device 142.

The client terminal 200 transfers the new file generation request to the data management unit 130 based on the place information.

The data management unit 130 generates the new file based on the management information included in the directory-based file management policy at step S240.

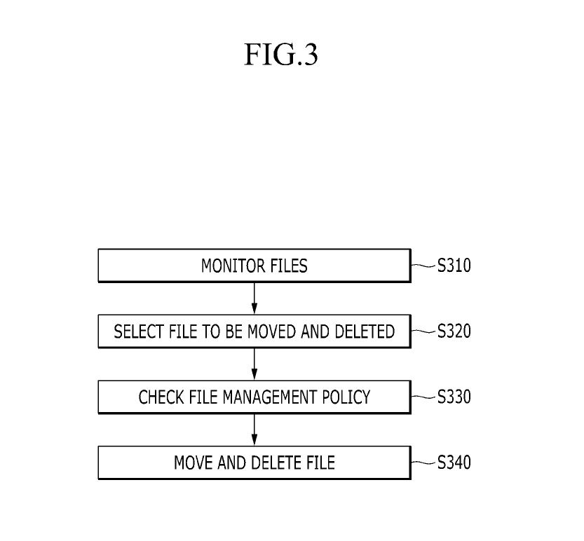

FIG. 3 is a flowchart illustrating a method for managing files in accordance with an exemplary embodiment of the present invention.

Referring to FIG. 3, the metadata management unit 120 monitors the metadata of files periodically or when an event is generated at step S310, and selects a file to be moved and deleted in accordance with a file management policy established based on a directory at step S320.

The metadata management unit 120 transfers information about the moved and deleted file to the data management unit 130.

The data management unit 130 checks a file management policy established for the selected file to be moved and deleted at step S330, and takes measures to move and delete the selected file in accordance with the checked file management policy at step S340.

Meanwhile, the data management unit 120 may monitor files periodically or when an event is generated, and select a file to be moved and deleted in accordance with a file management policy established in a directory unit.

According to an exemplary embodiment of the present invention, there is an advantage in that managed information and analyzed information are small and rapid and thus overhead is reduced because pieces of information are collected and analyzed based on a directory unlike in an existing file and block-based method.

Furthermore, rapid analyses are made possible because a range of analyses into the association of a file is reduced. Furthermore, several modifications are possible because a directory unit having a minimum tracing unit is controlled if necessary.

Furthermore, cache occupancy of unnecessary data can be reduced through more rapid processing because a policy is established based on a directory and the established policy is applied to a new file.

The exemplary embodiments of the present invention are not implemented using only the aforementioned method and apparatus, but may be implemented using a program for realizing a function corresponding to the construction according to the exemplary embodiment of the present invention or a recording medium on which the program is recorded. The implementation can be easily achieved by a person having ordinary skill in the art to which the present invention pertains from the above exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for managing files in a hybrid storage system, the apparatus comprising:
first and second storage devices for storing files according to a file management policy based on a directory unit;
a metadata management unit for establishing a file management policy based on a directory unit; and
a data management unit for managing files of the first and second storage devices in accordance with the established file management policy based on the directory unit.

2. The apparatus of claim 1, wherein managing the files comprise at least one of monitoring, place, re-place, and movement of a file belonging to a corresponding directory.

3. The apparatus of claim 1, wherein the data management unit generates a new file in accordance with a file management policy established in a directory of the first and second storage devices in which the new file will be disposed.

4. The apparatus of claim 1, wherein
at least one of the metadata management unit and the data management unit selects a file to be moved and deleted in accordance with the file management policy based on the directory unit, and
the management unit moves and deletes the selected file.

5. The apparatus of claim 1, wherein the metadata management unit collects pieces of utilization information about the file in a unit of a directory to which the file belongs, analyzes the pieces of collected utilization information, and establishes the directory-based file management policy based on a result of the analysis.

6. The apparatus of claim 1, wherein the first and second storage devices have different speeds.

7. A file management method performed by an apparatus for managing files in a hybrid storage system comprising first and second storage devices for storing files, the file management method comprising:
establishing a file management policy based on a directory unit; and
managing the files stored in the first and second storage devices in accordance with the file management policy established based on the directory unit.

8. The file management method of claim 7, wherein managing the files stored in the first and second storage devices comprises:
selecting a file to be managed in accordance with the file management policy established based on the directory unit; and
processing the file to be managed in accordance with a file management policy established in a corresponding directory,
wherein the file to be managed comprises at least one of a file to be moved and a file to be deleted.

9. The file management method of claim 7, wherein establishing a file management policy based on a directory unit comprises:
collecting pieces of utilization information about a file based on the directory unit and analyzing the pieces of collected utilization information; and
establishing a file management policy for a directory to which the file will belong based on a result of the analysis.

10. The file management method of claim 7, wherein establishing a file management policy based on a directory unit comprises establishing the file management policy based on the directory unit based on information received from a client terminal.

11. The file management method of claim 7, wherein managing the files stored in the first and second storage devices comprises:
receiving a new file generation request from a client terminal;
checking a file management policy for a directory in which a new file will be placed; and
generating the new file in accordance with the file management policy for the directory in which the new file will be placed.

12. The file management method of claim 7, wherein the file management policy comprises place information and management information.
